(19) United States
(12) Patent Application Publication
(10) Pub. No.: US 2021/0306127 A1
(43) Pub. Date: Sep. 30, 2021

(54) MINIMIZATION OF BASE STATION TO BASE STATION INTERFERENCE IN TDD NETWORKS

(71) Applicant: Telefonaktiebolaget LM Ericsson (publ), Stockholm (SE)

(72) Inventors: Mårten SUNDBERG, Årsta (SE); Sebastian FAXÉR, Stockholm (SE); David ASTELY, Bromma (SE)

(21) Appl. No.: 17/266,491

(22) PCT Filed: Aug. 7, 2019
(86) PCT No.: PCT/SE2019/050729

§ 371 Date: Feb. 5, 2021

Related U.S. Application Data
(60) Provisional application No. 62/716,783, filed on Aug. 9, 2018.

(51) Int. Cl. H04L 5/14; H04L 5/00

(52) U.S. Cl. CPC H04L 5/14; H04L 5/0073; H04L 5/0048

(57) ABSTRACT

Methods and apparatuses are disclosed for minimization of network node to network node interference in Time Division Duplex (TDD) network. According to one embodiment, a method in a network node for re-mote interference management includes receiving information indicating a position for a reference signal within a communication signal slot, the position being indicated being indicated relative to a reference point associated with a downlink-to-uplink switch; at least one of transmitting the reference signal and receiving the reference signal based at least in part on the received information; and determining whether remote interference is present based at least in part on at least one of the received reference signal and the received information indicating the position of the reference signal.

### TECHNICAL FIELD

Wireless communication and in particular, to minimization of base station (BS) to BS interference in time division duplex (TDD) networks.

### BACKGROUND

Interference Protection in TDD Networks

Wireless cellular networks are built up of cells, each cell defined by a certain coverage area of a network node, such as a radio base station (BS). The BSs wirelessly communicate with terminals, such as wireless devices (WDs)/user equipments (UEs) in the network. The communication is carried out in either paired or unpaired spectrum. In cases of paired spectrum, the downlink (DL) and uplink (UL) directions may be separated in frequency, called Frequency Division Duplex (FDD). In cases of unpaired spectrum, the DL and UL use the same spectrum, called Time Division Duplex (TDD). As the name implies, the DL and UL are separated in the time domain, typically with guard periods (GP) between them. A guard period serves several purposes. For example, the processing circuitry at the BS and UE require sufficient time to switch between transmission and reception, however this is typically a fast procedure and does not significantly contribute to the requirement of the guard period size. There is one guard period at a downlink-to-uplink switch and one guard period at an uplink-to-downlink switch. Because the guard period at the uplink-to-downlink switch is merely required to give enough time to allow BS and UE to switch between reception and transmission, and consequently is typically nominal, such guard period at the uplink-to-downlink switch will not be discussed herein, for the sake of brevity.

The guard period at the downlink-to-uplink switch (GP), however, should be sufficiently large to allow a UE to receive a (time-delayed) DL grant scheduling the UL and transmit the UL signal with proper timing advance (i.e., compensating for the propagation delay) such that the signal is received in the UL part of the frame at the BS. In fact, the guard period at the uplink-to-downlink switch is created with an offset to the timing advance. Thus, the GP should be larger than two times the propagation time towards a UE at the cell edge, otherwise, the UL and DL signals in the cell will interfere. Because of this, the GP is typically chosen to depend on the cell size such that larger cells (i.e., larger inter-site distances) have a larger GP and vice versa.

Additionally, the guard period reduces DL-to-UL interference between BSs by allowing a certain propagation delay between cells without having the DL transmission of a first BS enter the UL reception of a second BS. In a typical macro network, the DL transmission power can be on the order of 20 dB larger than the UL transmission power, and the pathloss between base stations, perhaps above roof top and in line-of-sight (LOS), may often be much smaller than the pathloss between base stations and terminals (in non-line-of-sight (NLOS)). Hence, if the UL is interfered by the DL of other cells, so called cross-link interference, the UL performance can be seriously degraded. Because of the large transmit power discrepancy between UL and DL and/or propagation conditions, cross-link interference can be detrimental to system performance not only for the co-channel case (where DL interferes with UL on the same carrier) but also for the adjacent channel case (where DL of one carrier interferes with UL on an adjacent carrier). Because of this, TDD macro networks are typically operated in a synchronized and aligned fashion where the symbol timing is aligned, and a semi-static TDD UL/DL pattern is used which is the same for all the cells in the network (NW) by aligning uplink and downlink periods so that they do not occur simultaneously. The reasoning is to reduce interference between uplink and downlink. Typically, operators with adjacent TDD carriers also synchronize their TDD UL/DL patterns to avoid adjacent channel cross-link interference.

The principle of applying a GP at the downlink-to-uplink switch, to avoid DL-to UL interference between BSs is shown in FIG. 1, as an example, where a victim BS (V) is being (at least potentially) interfered with by an aggressor BS (A). The aggressor is sending a DL signal to a device in its cell, but the DL signal also reaching the victim BS. The propagation loss is not enough to protect V from the signals of A, which is trying to receive a signal from another UE (not shown in the figure) in its cell. The signal has propagated a distance (d) and due to propagation delay, the experienced frame structure alignment of A at V is shifted/delayed τ second, proportional to the propagation distance d. As can be seen from FIG. 1, although the DL part of the aggressor BS (A) is delayed, it does not enter the UL region of the victim (V) due to the guard period used. Accordingly, in this example, the system design serves its purpose. As a side note, the aggressor DL signal does undergo attenuation, but may be very high relative to the received victim UL signal due to differences in transmit powers in terminals and base stations as well as propagation condition differences for base station-to-base station links and terminal-to-base station links.

It is noted that the terms victim and aggressor are only used here to illustrate why typical TDD systems are designed as they are. The victim can also act as an aggressor and vice versa and even simultaneously since channel reciprocity exists between the BSs.

New Radio (NR) Frame Structure

The Radio Access Technology (RAT) 3rd Generation Partnership Project (3GPP) next generation mobile wireless communication system (5G) or new radio (NR), supports a diverse set of use cases and a diverse set of deployment scenarios. The later includes deployment at both low frequencies (e.g., 100 s of MHz), similar to the RAT Long-Term Evolution (LTE) today, and very high frequencies (e.g., mm waves in the tens of GHz).

Similar to LTE, NR uses OFDM (Orthogonal Frequency Division Multiplexing) in the downlink (i.e., from a network node, e.g. gNB, eNB, to a user equipment (UE)). The network node may also be referred to herein interchangeably as base station. The basic NR physical resource over an antenna port can thus be seen as a time-frequency grid as illustrated in FIG. 2, where a resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2^{α}) kHz where α∈(0,1,2,3,4). Δf=15 kHz is the basic (or reference) subcarrier spacing that is also used in LTE.

In the time domain, downlink and uplink transmissions in NR will be organized into equally-sized subframes of 1 ms each, similar to LTE. A subframe can be further divided into multiple slots or subslots of equal duration. The slot length for subcarrier spacing Δf=(15×2^{α}) kHz is 1/2^{α} ms. There is only one slot per subframe at Δf=15 kHz and a slot consists of 14 OFDM symbols.

Downlink transmissions are dynamically scheduled, i.e., the gNB transmits downlink control information (DCI) in each slot about which UE data is to be transmitted to and which resource blocks in the current downlink slot the data is transmitted on. This control information is typically transmitted in the first one or two OFDM symbols in each slot in NR. The control information is carried on the Physical Downlink Control Channel (PDCCH) and data is carried on the Physical Downlink Shared Channel (PDSCH). A UE first detects and decodes PDCCH and if a PDCCH is decoded successfully, the UE can then decode the corresponding PDSCH based on the decoded control information in the PDCCH.

In addition to PDCCH and PDSCH, there are also other channels and reference signals transmitted in the downlink.

Uplink data transmissions, carried on Physical Uplink Shared Channel (PUSCH), are also dynamically scheduled by the network node, e.g., gNB by transmitting a DCI. In case of TDD operation, the DCI (which is transmitted in the DL region) typically indicates a scheduling offset so that the PUSCH is transmitted in a slot in the UL region.

Uplink-downlink Configurations in TDD

In TDD, some subframes/slots are allocated for uplink transmissions and some subframes/slots are allocated for downlink transmissions. The switch between downlink and uplink occurs in the so called special subframes (in 3GPP Long Term Evolution (LTE)) or flexible slots (in NR).

In LTE, seven different uplink-downlink configurations may be provided, see for example Table 1.

TABLE 1
LTE uplink-downlink configurations (from 3GPP Technical
Specification (TS) 36.211, Table 4.2-2)

| | Downlink-to- | | | | | | | | | | |
|---|---|---|---|---|---|---|---|---|---|---|---|
| Uplink- | Uplink | | | | | | | | | | |
| downlink | Switch-point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

The size of the guard period (and hence the number of symbols for downlink pilot time slot (DwPTS) (downlink transmission in a special subframe) and uplink pilot time slot (UpPTS) (uplink transmission in a special subframe) in the special subframe) can also be configured from a set of possible selections.

NR on the other hand provides many different uplink-downlink configurations. There may be 10 to 320 slots per radio frame (where each radio frame has a duration of 10 ms) depending on subcarrier spacing. The OFDM symbols in a slot are classified as ‘downlink’ (denoted ‘D’), ‘flexible’ (denoted ‘X’), or ‘uplink’ (denoted ‘U’). A semi-static TDD UL-DL configuration may be used where the TDD configuration is RRC configured using the IE TDD-UL-DL-ConfigCommon as follows:

### TDD-UL-DL-ConfigCommon::=SEQUENCE {

Reference SCS used to determine the time domain boundaries in the UL-DL pattern which must be common across all subcarrier specific
virtual carriers, i.e., independent of the actual subcarrier spacing using for data transmission.
Only the values 15 or 30 kHz (<6 GHz), 60 or 120 kHz (>6 GHz) are applicable.
Corresponds to L1 parameter ‘reference-SCS’ (see 3GPP TS 38.211, section FFS_Section)

referenceSubcarrierSpacing SubcarrierSpacing
Periodicity of the DL-UL pattern. Corresponds to L1 parameter ‘DL-UL-transmission-periodicity’ (see 3GPP TS 38.211, section FFS Section)

dl-UL-TransmissionPeriodicity ENUMERATED {ms0p5, ms0p625, ms1, ms1p25, ms2, ms2p5, ms5, ms10} OPTIONAL,
Number of consecutive full DL slots at the beginning of each DL-UL pattern.
Corresponds to L1 parameter ‘number-of-DL-slots’ (see 33GPP TS 8.211, Table 4.3.2-1)

nrofDownlinkSlots INTEGER (0 . . . maxNrofSlots)
Number of consecutive DL symbols in the beginning of the slot following the last full DL slot (as derived from nrofDownlinkSlots).
If the field is absent or released, there is no partial-downlink slot.
Corresponds to L1 parameter ‘number-of-DL-symbols-common’ (see 3GPP TS 38.211, section FFS_Section).

nrofDownlinkSymbols INTEGER (0 . . . maxNrofSymbols−1)
Number of consecutive full UL slots at the end of each DL-UL pattern.
Corresponds to L1 parameter ‘number-of-UL-slots’ (see 3GPP TS 38.211, Table 4.3.2-1)

nrofUplinkSlots INTEGER (0 . . . maxNrofSlots)
Number of consecutive UL symbols in the end of the slot preceding the first full UL slot (as derived from nrofUplinkSlots).
If the field is absent or released, there is no partial-uplink slot.
Corresponds to L1 parameter ‘number-of-UL-symbols-common’ (see 3GPP TS 38.211, section FFS_Section)

nrofUplinkSymbols INTEGER (0 . . . maxNrofSymbols−1)

Alternatively, the slot format can be dynamically indicated with a Slot Format Indicator (SFI) conveyed with DCI Format 2_0. Regardless of whether a dynamic or semi-static TDD configuration is used in NR, the number of UL and DL slots, as well as the guard period (e.g., the number of UL and DL symbols in the flexible slot(s)) may be almost arbitrarily configured within the TDD periodicity. This allows for very flexible uplink-downlink configurations.

Atmospheric Ducting

In certain weather conditions and in certain regions of the world a ducting phenomenon can happen in the atmosphere. The appearance of the duct is dependent on for example temperature and humidity and may appear to be able to “channel” the signal to help it propagate a significantly longer distance than if the duct was not present. An atmospheric duct is a layer in which rapid decrease in the refractivity of the lower atmosphere (the troposphere) occurs. In this way, atmospheric ducts can trap the propagating signals in the ducting layer, instead of radiating out in space. Thus, most of the signal energy propagates in the ducting layer, which acts as a wave guide. Therefore, trapped signals can propagate through beyond-line-of-sight distances with relatively low path loss, sometimes even lower than in line-of-sight propagation. A ducting event is typically temporary and can have a time duration from a couple of minutes to several hours.

Combining the knowledge of the TDD system design and the presence of an atmospheric duct, the distance d in FIG. 1, where an aggressor BS can interfere with a victim BS, can be greatly increased. Since the phenomenon is only appearing in certain parts of the world under certain conditions, this has typically not been considered in designs of cellular systems using unpaired spectrum. The implication is that a DL transmission can suddenly enter the UL region as interference (I), which is illustrated in FIG. 3, as an example.

FIG. 3 illustrates a single radio link, but when the atmospheric ducting occurs, a BS can be interfered by thousands of BSs. The closer the aggressor the shorter the propagation delay, and the stronger the interference. Hence, the interference experienced at the victim BS typically has a slope characteristic, as illustrated in FIG. 4, for example.

One method of detecting interference between BSs is for the victim BS (i.e., a BS that has detected it is being interfered due to atmospheric ducting) to send a specific reference signals that can be detected by an aggressor BS. The aggressor BS can in this case adapt its transmission to avoid the interference situation. One such adaptation is to for example blank, or reduce the duration of, its downlink transmission, effectively increasing the guard period.

It can be noted that due to channel reciprocity, it is likely that an aggressor BS is also the victim of other BSs transmission, as well.

In case different guard periods are used in different cells, an aggressor BS identifying a reference signal transmitted for example in the last symbol of a DL transmission cannot understand to which extent the victim is being interfered, assuming that the aggressor and victim BS has no knowledge of the guard period applied in other cells than its own.

As can be seen from FIG. 5, the point in the UL frame (vertical arrow) where the reference signal (R) occurs is at different positions depending on which base station is interfering (since applying different guard period/special subframe configuration/flexible slot configuration) and hence is not uniquely known to both). Note that, as discussed above, the term aggressor and victim here can be a bit misleading since both BSs act as victim and aggressor (simultaneously assuming symmetric traffic), but the naming is kept from previous examples for consistency.

### SUMMARY

Some embodiments advantageously provide methods and apparatuses for minimization of network node to network node interference in Time Division Duplex (TDD) network.

According to one aspect of the present disclosure, a method in a network node for remote interference management is provided. The method includes receiving information indicating a position for a reference signal within a communication signal slot, the position being indicated relative to a reference point associated with a downlink-to-uplink switch. The method includes at least one of transmitting the reference signal and receiving the reference signal based at least in part on the received information. The method includes determining whether remote interference is present based at least in part on at least one of the received reference signal and the received information indicating the position of the reference signal.

In some embodiments of this aspect, the method further includes determining an extent of the remote interference based at least in part on at least one of the received reference signal and the received information indicating the position of the reference signal. In some embodiments of this aspect, the information indicates the position of the reference signal by mapping the reference signal to physical resources. In some embodiments of this aspect, the information indicates a time offset for the reference signal. In some embodiments of this aspect, the information indicating the position of the reference signal is received via Operations, Administration and Maintenance, OAM, signalling. In some embodiments of this aspect, the reference signal is received from a second network node. In some embodiments of this aspect, the position is a fixed position. In some embodiments of this aspect, the reference point is a start of a guard period. In some embodiments of this aspect, the downlink-to-uplink switch corresponds to a time division duplex, TDD, configuration. In some embodiments of this aspect, the indicated position is in which Orthogonal Frequency Division Multiplexing, OFDM, symbol the reference signal is to be transmitted in.

In some embodiments of this aspect, the indicated position corresponds to a last downlink, DL, symbol before a start of a smallest guard period. In some embodiments of this aspect, the method further includes determining an extent to which the network node is causing interference to a second network node based at least in part on the received reference signal and the received information indicating the position of the reference signal; and increasing a guard period of the network node based at least in part on the determined extent to which the network node is causing interference to the second network node. In some embodiments of this aspect, the method further includes determining whether a difference between a symbol on which the reference signal is received and a symbol on which the reference signal was transmitted is greater than a guard period of the network node, the indicated position indicating the symbol on which the reference signal was transmitted. In some embodiments of this aspect, the method further includes if the difference is greater than the guard period, increasing the guard period.

According to a second aspect of the present disclosure, a network node configured to communicate with a wireless device, WD, is provided. The network node includes processing circuitry. The processing circuitry is configured to cause the network node to receive information indicating a position for a reference signal within a communication signal slot, the position being indicated relative to a reference point associated with a downlink-to-uplink switch. The processing circuitry is configured to cause the network node to at least one of transmit the reference signal and receive the reference signal based at least in part on the received information. The processing circuitry is configured to cause the network node to determine whether remote interference is present based at least in part on at least one of the received reference signal and the received information indicating the position of the reference signal.

In some embodiments of this aspect, the processing circuitry is further configured to cause the network node to determine an extent of the remote interference based at least in part on at least one of the received reference signal and the received information indicating the position of the reference signal. In some embodiments of this aspect, the information indicates the position of the reference signal by mapping the reference signal to physical resources. In some embodiments of this aspect, the information indicates a time offset for the reference signal. In some embodiments of this aspect, the information indicating the position of the reference signal is received via Operations, Administration and Maintenance, OAM, signalling. In some embodiments of this aspect, the reference signal is received from a second network node. In some embodiments of this aspect, the position is a fixed position.

In some embodiments of this aspect, the reference point is a start of a guard period. In some embodiments of this aspect, the downlink-to-uplink switch corresponds to a time division duplex, TDD, configuration. In some embodiments of this aspect, the indicated position is in which Orthogonal Frequency Division Multiplexing, OFDM, symbol the reference signal is to be transmitted in. In some embodiments of this aspect, the indicated position corresponds to a last downlink, DL, symbol before a start of a smallest guard period. In some embodiments of this aspect, the processing circuitry is further configured to cause the network node to at least one of: determine an extent to which the network node is causing interference to a second network node based at least in part on the received reference signal and the received information indicating the position of the reference signal; and increase a guard period of the network node based at least in part on the determined extent to which the network node is causing interference to the second network node. In some embodiments of this aspect, the processing circuitry is further configured to cause the network node to determine whether a difference between a symbol on which the reference signal is received and a symbol on which the reference signal was transmitted is greater than a guard period of the network node, the indicated position indicating the symbol on which the reference signal was transmitted. In some embodiments of this aspect, the processing circuitry is further configured to cause the network node to, if the difference is greater than the guard period, increase the guard period.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an exemplary TDD guard period design;

FIG. 2 illustrates an exemplary NR physical resource grid;

FIG. 3 illustrates an example of DL interference into UL region;

FIG. 4 illustrates an example of interference characteristics in the case of DL to UL interference;

FIG. 5 illustrates an example of different guard periods being used between interfering BSs;

FIG. 6 is a schematic diagram of an exemplary network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating an exemplary method implemented in a communication system including a host computer, a network node and a wireless device according to some embodiments of the present disclosure;

FIG. 9 is a flowchart illustrating an exemplary method implemented in a communication system including a host computer, a network node and a wireless device according to some embodiments of the present disclosure;

FIG. 10 is a flowchart illustrating an exemplary method implemented in a communication system including a host computer, a network node and a wireless device according to some embodiments of the present disclosure;

FIG. 11 is a flowchart illustrating an exemplary method implemented in a communication system including a host computer, a network node and a wireless device according to some embodiments of the present disclosure;

FIG. 12 is a flowchart of an example process in a network node according to some embodiments of the present disclosure;

FIG. 13 is a flowchart of an exemplary process in a transmitter network node according to some embodiments of the present disclosure;

FIG. 14 is a flowchart of an exemplary process in a receiver network node according to some embodiments of the present disclosure;

FIG. 15 illustrates a fixed mapping depending irrespective of different special subframe configurations according to some embodiments of the present disclosure;

FIG. 16 illustrates an example of adaptive mapping using different combinations of offsets depending on different special subframe configurations according to some embodiments of the present disclosure;

FIG. 17 illustrates an example of adaptive mapping using different frequency subbands depending on different special subframe configurations according to some embodiments of the present disclosure; and

FIG. 18 illustrates different reference sequences for different special subframe configurations according to some embodiments of the present disclosure.

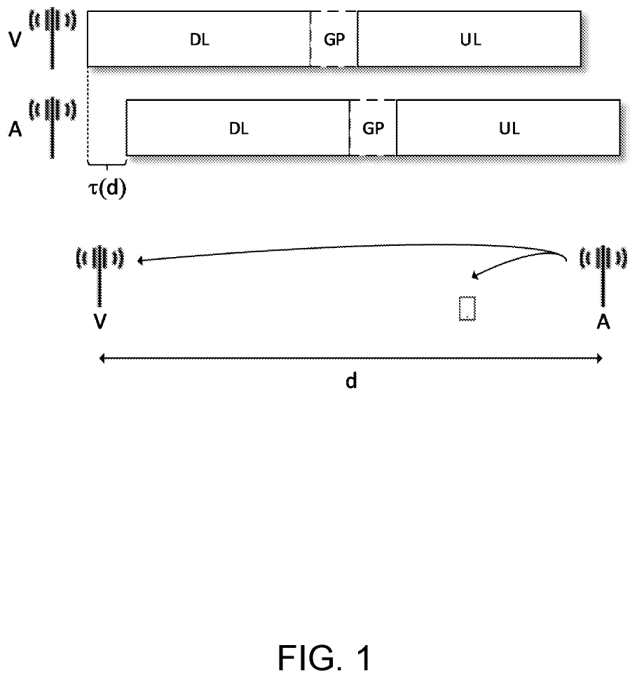

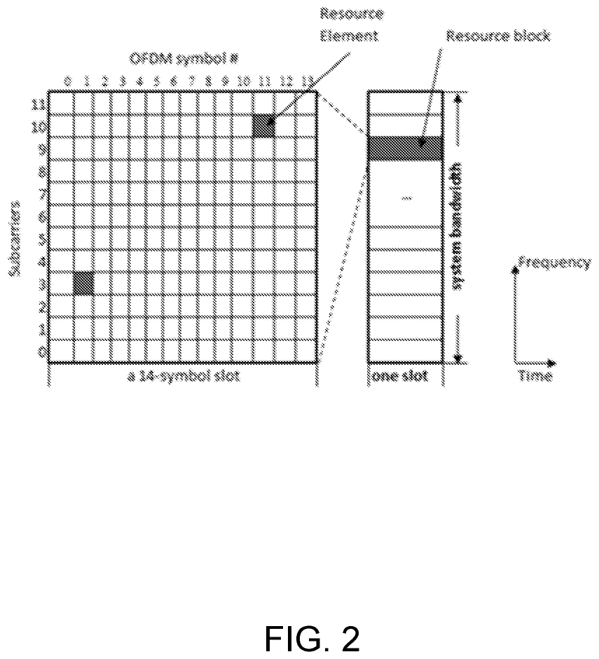

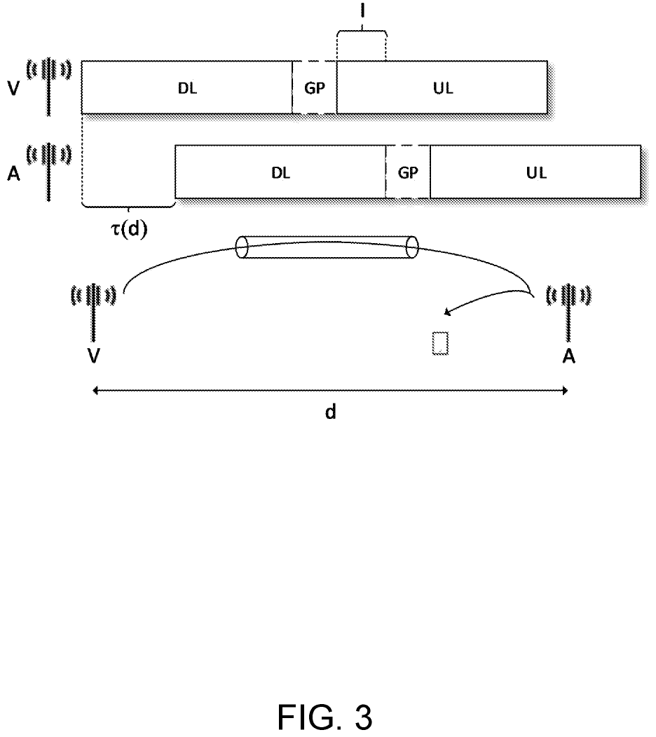

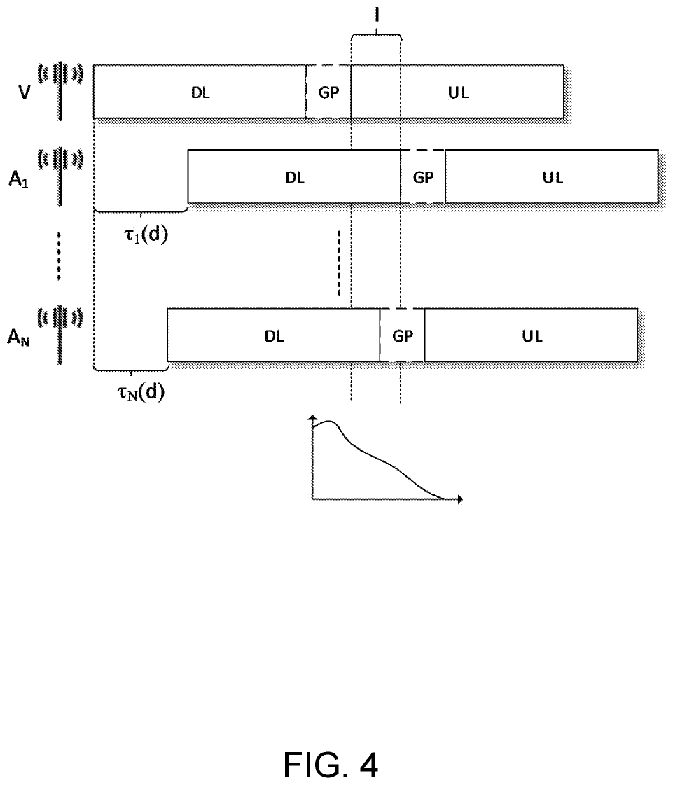

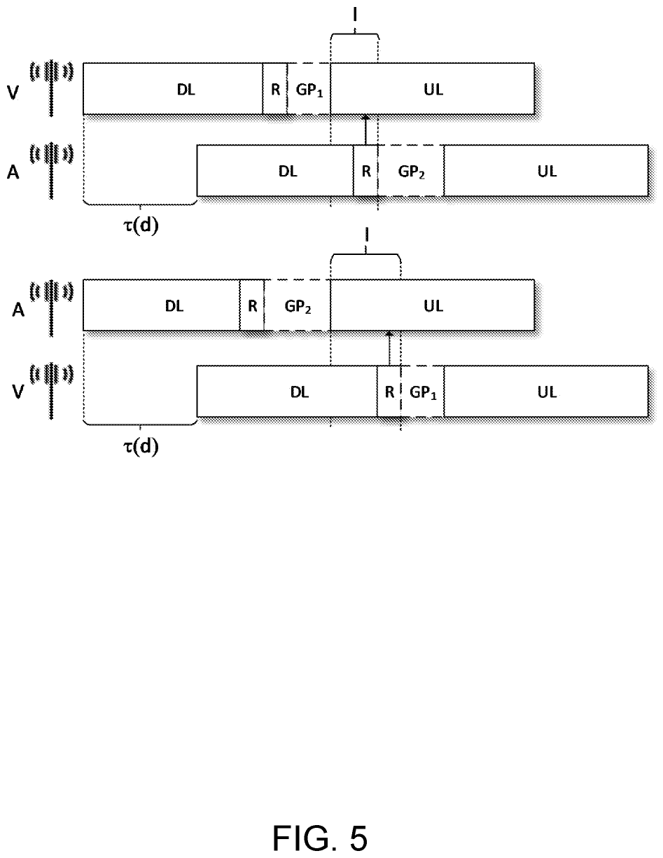

### DETAILED DESCRIPTION

Some embodiments advantageously provide methods and apparatuses for communicating information corresponding to a reference signal to a receiver network node, the information indicating an extent to which the receiver network node is causing interference to a transmitter network node.

In one embodiment, knowledge is provided to a receiver network node, so that the receiver network node can determine how to adjust its transmission/reception time structure to avoid causing interference to (parts of) the network.

In one embodiment, the adjustment of the transmission/reception time structure is determining the required guard period size and position in the time frame structure.

In one embodiment, the knowledge to a receiver network node is provided as a result of the detection of a reference signal.

In some embodiments, the reference signal may be designed using at least two main embodiments, which will be further elaborated on in the detailed description section.

In a first of the at least two main embodiments, a mapping of the reference signal is used onto the physical resources, where the mapping is different depending on where it is transmitted in time. The time reference here may be a relative or absolute reference to the overall frame structure and hence when the reference signal mapping is detected, also the symbol where it has been transmitted at the transmitter network node is known to the receiver network node.

In a second of the at least two main embodiments, a reference signal structure is used so that the detection of the reference signal will carry information about in which relative or absolute time reference it is sent in.

Thus, according to at least some of the principles in the present disclosure, an aggressor BS, interfering with its DL in another victim BS's UL, can understand to what extent the interference occurs without knowing the details of the victim base station's frame structure (for example signaled through Operations, Administration and Maintenance (OAM) or a backhaul signaling solution).

It should be noted that although the interference problem is described to stem from atmospheric ducting, the same situation could occur in a network where a guard period that is too small has been selected for the deployment. Hence, solutions in this disclosure may also applicable to this case, although not considered the typical scenario.

Before describing in detail exemplary embodiments, it is noted that the embodiments reside primarily in combinations of apparatus components and processing steps related to minimization of BS to BS interference in time division duplex (TDD) networks. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In this present disclosure a network node is also referred to as a base station. This is a more general term and can correspond to any type of radio network node or any network node, which communicates with a UE and/or with another network node. Examples of network nodes are NodeB, base station (BS), multi-standard radio (MSR) radio node such as MSR BS, eNodeB, gNodeB (gNB). MeNB, SeNB, network controller, radio network controller (RNC), base station controller (BSC), road side unit (RSU), relay node, integrated access and backhaul (IAB) node, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobile Management Entity (MME), etc.), Operations & Maintenance (O&M), Operations Support Systems (OSS), Self-Organizing Network (SON), positioning node (e.g. Evolved Serving Mobile Location Center (E-SMLC)) etc.

The term radio access technology, or RAT, may refer to any RAT e.g., Universal Terrestrial Radio Access (UTRA), Evolved-UTRA (E-UTRA), narrow band internet of things (NB-IoT), WiFi, Bluetooth, next generation RAT (NR), 4G, 5G, etc. Any of the first and the second nodes may be capable of supporting a single or multiple RATs.

The term reference signal used herein can be any physical signal or physical channel. Examples of downlink reference signals are Primary Synchronization Signal (PSS), Secondary Synchronization Signal (SSS), Cell-specific Reference Signal (CRS), Positioning Reference Signal (PRS), Channel State Information Reference Signal (CSI-RS), Demodulation Reference Signal (DMRS), Narrowband Reference Signal (NRS), Narrowband PSS (NPSS), Narrowband SSS (NSSS), Synchronization Signal (SS), Multimedia Broadcast multicast service Single Frequency Network Reference Signal (MBSFN RS), etc. Examples of uplink reference signals are, for example, Sounding Reference Signal (SRS), DMRS, etc.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, IAB node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide knowledge to a receiver network node, so that the receiver network node can determine how to adjust its transmission/reception time structure to avoid causing interference to (parts of) the network.

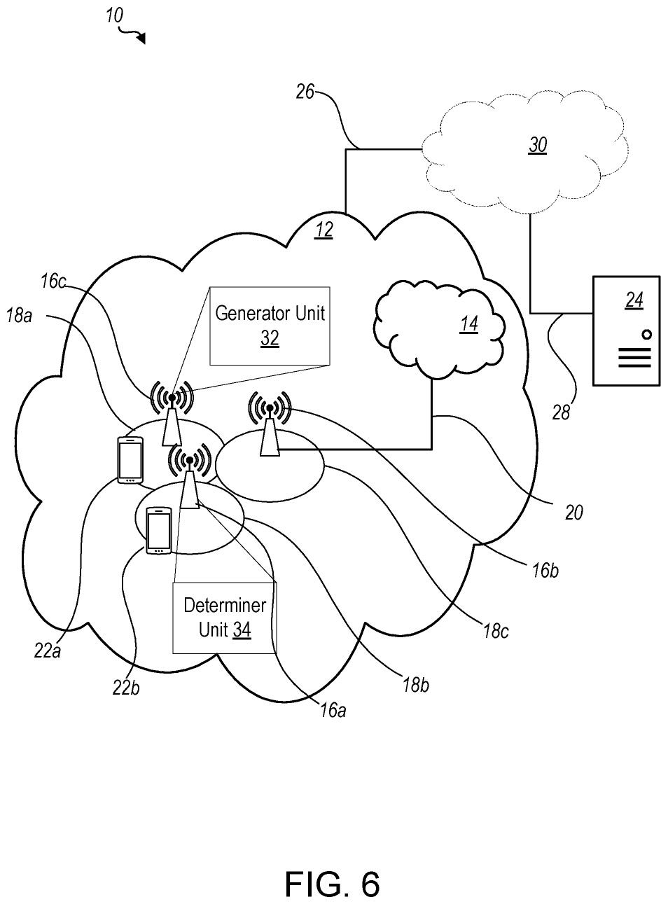

Returning to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

In one embodiment, a network node 16 is a transmitter network node 16c configured to include a generator unit 32 which is configured to communicate information corresponding to a reference signal to a receiver network node 16a, the information corresponding to the reference signal indicating an extent to which the receiver network node 16a is causing interference to the transmitter network node 16c. In some embodiments, the information indicates which Orthogonal Frequency Division Multiplexing (OFDM) symbol the reference signal is transmitted in. In some embodiments, wherein the generator unit 32 is further configured to communicate the reference signal to the receiver network node 16a. In some embodiments, the communicated reference signal, the communicated information, and a number of symbols in a guard period (GP) of the receiver network node 16a permits the receiver network node 16a to determine the extent to which the receiver network node 16a is causing interference to the transmitter network node 16c. In some embodiments, the information indicates the special subframe configuration of the reference signal. In some embodiments, the information indicates at least one of a length of the guard period, at least one downlink (DL) symbol, and at least one uplink (UL) symbol associated with the reference signal. In some embodiments, the generator unit 32 is further configured to communicate information corresponding to the reference signal to the receiver network node 16a by being further configured to select and communicate a pre-defined sequence, the pre-defined sequence indicating at least one of the special subframe configuration of the reference signal, the guard period length associated with the reference signal, and a number of downlink (DL) symbols within the slot that the reference signal is transmitted in.

According to another embodiment, a network node 16 is configured as a receiver network node 16a and includes a determiner unit 34 which is configured to receive information corresponding to a reference signal from a transmitter network node 16c; and determine an extent to which the receiver network node 16a is causing interference to the transmitter network node 16c based at least in part on the received information corresponding to the reference signal. In some embodiments, the determiner unit 34 is further configured to increase a guard period based on the determined extent to which the receiver network node 16a is causing interference to the transmitter network node 16c. In some embodiments, the determiner unit 34 is further configured to receive the reference signal from the transmitter network node 16c. In some embodiments, the determiner unit 34 is configured to determine the extent to which the receiver network node 16a is causing interface to the transmitter network node 16c by being further configured to determine whether a difference between an uplink symbol of the received reference signal and a known symbol on which the reference signal was transmitted is greater than a guard period. In some embodiments, the determiner unit 34 is further configured to, if the difference is greater than the guard period, increase the guard period. In some embodiments, the received information indicates which Orthogonal Frequency Division Multiplexing (OFDM) symbol the reference signal is transmitted in. In some embodiments, the received information indicates the special subframe configuration of the reference signal. In some embodiments, the received information indicates at least one of a length of the guard period, at least one downlink (DL) symbol, and at least one uplink (UL) symbol associated with the reference signal.

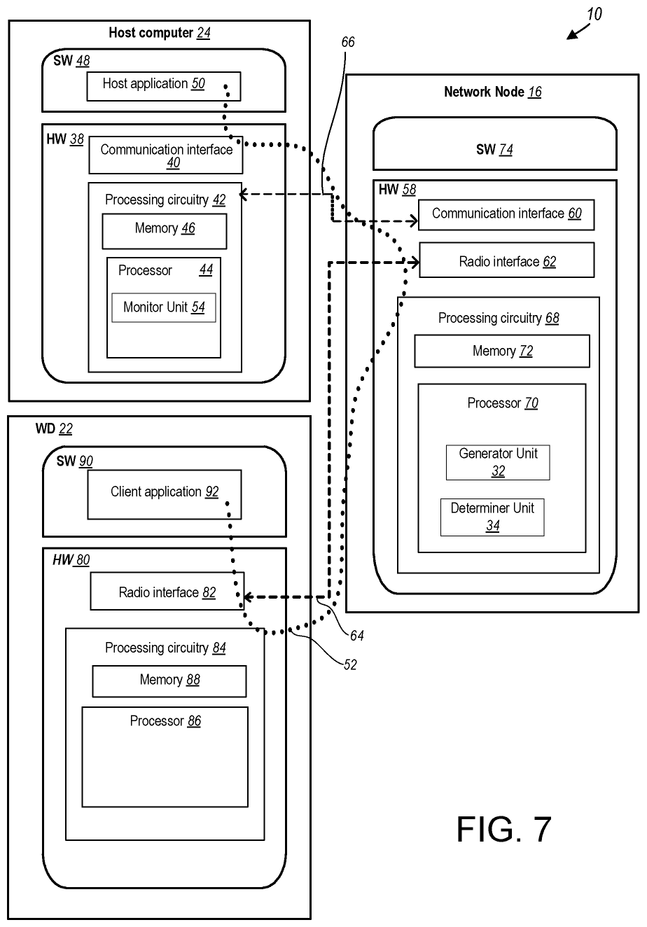

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to, and/or receive from the network node 16 and/or the wireless device 22.

The communication system 10 further includes a network node 16 provided in a communication system 10 and comprising hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

For example, processing circuitry 68 may include determiner unit 34 which is configured to cause the network node 16 to receive information indicating a position for a reference signal within a communication signal slot, the position being indicated relative to a reference point associated with a downlink-to-uplink switch; at least one of transmit the reference signal and receive the reference signal based at least in part on the received information; and determine whether remote interference is present based at least in part on at least one of the received reference signal and the received information indicating the position of the reference signal. In some embodiments, the processing circuitry 68 is further configured to cause the network node 16 to determine an extent of the remote interference based at least in part on at least one of the received reference signal and the received information indicating the position of the reference signal. In some embodiments, the information indicates the position of the reference signal by mapping the reference signal to physical resources. In some embodiments, the information indicates a time offset for the reference signal. In some embodiments, the information indicating the position of the reference signal is received via Operations, Administration and Maintenance, OAM, signalling. In some embodiments, the reference signal is received from a second network node. In some embodiments, the position is a fixed position. In some embodiments, the reference point is a start of a guard period. In some embodiments, the downlink-to-uplink switch corresponds to a time division duplex, TDD, configuration. In some embodiments, the indicated position is in which Orthogonal Frequency Division Multiplexing, OFDM, symbol the reference signal is to be transmitted in. In some embodiments, the indicated position corresponds to a last downlink, DL, symbol before a start of a smallest guard period. In some embodiments, the processing circuitry 68 is further configured to cause the network node 16 to at least one of: determine an extent to which the network node 16 is causing interference to a second network node 16 based at least in part on the received reference signal and the received information indicating the position of the reference signal; and increase a guard period of the network node 16 based at least in part on the determined extent to which the network node 16 is causing interference to the second network node 16. In some embodiments, the processing circuitry 68 is further configured to cause the network node 16 to at least one of: determine whether a difference between a symbol on which the reference signal is received and a symbol on which the reference signal was transmitted is greater than a guard period of the network node, the indicated position indicating the symbol on which the reference signal was transmitted; and if the difference is greater than the guard period, increase the guard period.

In some embodiments, processing circuitry 68 of the network node 16 may include generator unit 32 configured to communicate information corresponding to a reference signal to a receiver network node 16, the information corresponding to the reference signal indicating an extent to which the receiver network node 16 is causing interference to the transmitter network node 16. In some embodiments, the information indicates which Orthogonal Frequency Division Multiplexing (OFDM) symbol the reference signal is transmitted in. In some embodiments, the processing circuitry 68 is further configured to communicate the reference signal to the receiver network node 16. In some embodiments, the communicated reference signal, the communicated information, and a number of symbols in a guard period (GP) of the receiver network node 16 permits the receiver network node 16 to determine the extent to which the receiver network node 16 is causing interference to the transmitter network node 16. In some embodiments, the information indicates the special subframe configuration of the reference signal. In some embodiments, the information indicates at least one of a length of the guard period, at least one downlink (DL) symbol, and at least one uplink (UL) symbol associated with the reference signal. In some embodiments, the processing circuitry 68 is further configured to communicate information corresponding to the reference signal to the receiver network node 16 by being further configured to select and communicate a pre-defined sequence, the pre-defined sequence indicating at least one of the special subframe configuration of the reference signal, the guard period length associated with the reference signal, and a number of downlink (DL) symbols within the slot that the reference signal is transmitted in.

As discussed herein above, each network node 16 can be both an aggressor node and a victim node of interference from other network nodes. Thus, the processing circuitry 68 of the network node 16 may include both a generator unit 32, as well as, the determiner unit 34, as shown in FIG. 7.

In some embodiments, the determiner unit 34 is configured to receive information corresponding to a reference signal from a transmitter network node 16; and determine an extent to which the receiver network node 16 is causing interference to the transmitter network node 16 based at least in part on the received information corresponding to the reference signal. In some embodiments, the processing circuitry 68 is further configured to increase a guard period based on the determined extent to which the receiver network node 16 is causing interference to the transmitter network node 16. In some embodiments, the processing circuitry 68 is further configured to receive the reference signal from the transmitter network node 16. In some embodiments, the processing circuitry 68 is configured to determine the extent to which the receiver network node 16 is causing interface to the transmitter network node 16 by being further configured to determine whether a difference between an uplink symbol of the received reference signal and a known symbol on which the reference signal was transmitted is greater than a guard period. In some embodiments, the processing circuitry 68 is further configured to, if the difference is greater than the guard period, increase the guard period. In some embodiments, the received information indicates which Orthogonal Frequency Division Multiplexing (OFDM) symbol the reference signal is transmitted in. In some embodiments, the received information indicates the special subframe configuration of the reference signal. In some embodiments, the received information indicates at least one of a length of the guard period, at least one downlink (DL) symbol, and at least one uplink (UL) symbol associated with the reference signal.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as generator unit 32, and determiner unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

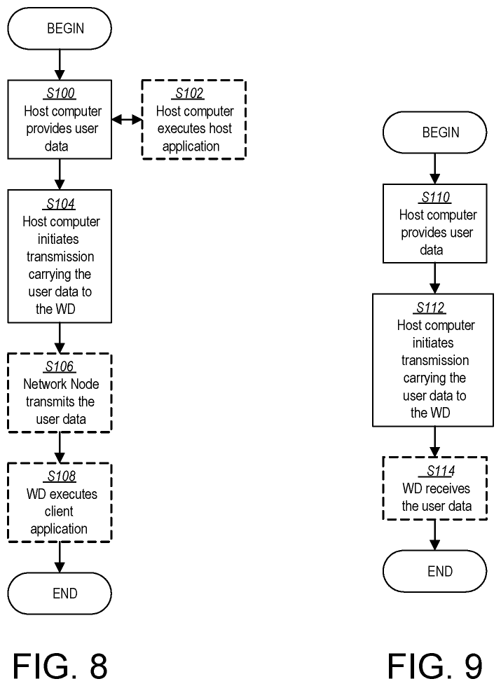

FIG. 8 is a flowchart illustrating an exemplary method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (block S100). In an optional substep of the first step, the host computer 24 provides the user data by executing a host application, such as, for example, the host application 50 (block S102). In a second step, the host computer 24 initiates a transmission carrying the user data to the WD 22 (block S104). In an optional third step, the network node 16 transmits to the WD 22 the user data which was carried in the transmission that the host computer 24 initiated, in accordance with the teachings of the embodiments described throughout this disclosure (block S106). In an optional fourth step, the WD 22 executes a client application, such as, for example, the client application 92, associated with the host application 50 executed by the host computer 24 (block S108).

FIG. 9 is a flowchart illustrating an exemplary method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (block S110). In an optional substep (not shown) the host computer 24 provides the user data by executing a host application, such as, for example, the host application 50. In a second step, the host computer 24 initiates a transmission carrying the user data to the WD 22 (block S112). The transmission may pass via the network node 16, in accordance with the teachings of the embodiments described throughout this disclosure. In an optional third step, the WD 22 receives the user data carried in the transmission (block S114).

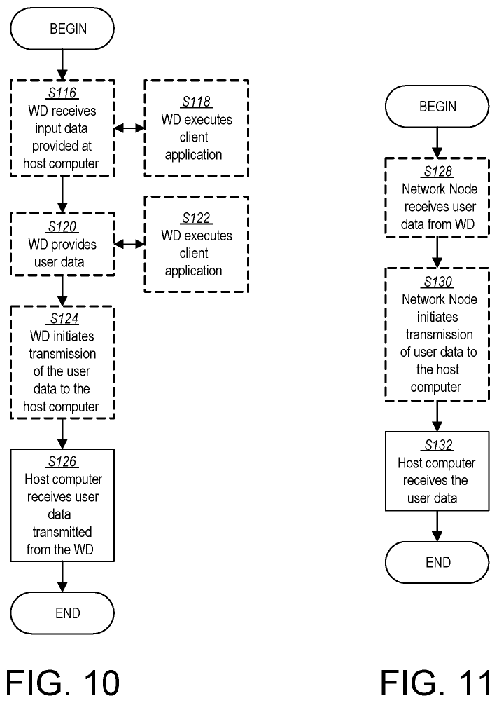

FIG. 10 is a flowchart illustrating an exemplary method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (block S116). In an optional substep of the first step, the WD 22 executes the client application 92, which provides the user data in reaction to the received input data provided by the host computer 24 (block S118). Additionally or alternatively, in an optional second step, the WD 22 provides user data (block S120). In an optional substep of the second step, the WD provides the user data by executing a client application, such as, for example, client application 92 (block S122). In providing the user data, the executed client application 92 may further consider user input received from the user. Regardless of the specific manner in which the user data was provided, the WD 22 may initiate, in an optional third substep, transmission of the user data to the host computer 24 (block S124). In a fourth step of the method, the host computer 24 receives the user data transmitted from the WD 22, in accordance with the teachings of the embodiments described throughout this disclosure (block S126).

FIG. 11 is a flowchart illustrating an exemplary method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (block S128). In an optional second step, the network node 16 initiates transmission of the received user data to the host computer 24 (block S130). In a third step, the host computer 24 receives the user data carried in the transmission initiated by the network node 16 (block S132).

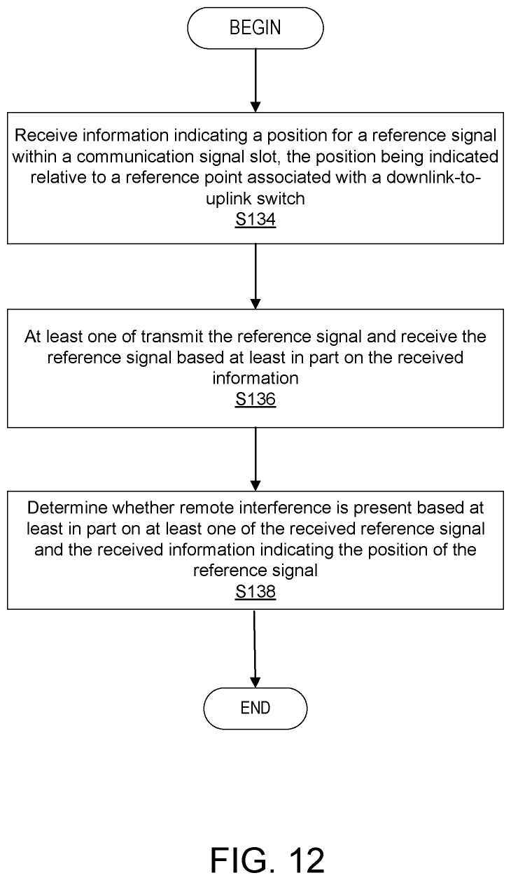

FIG. 12 is a flowchart of an example process in a network node 16 for remote interference management according to at least some of the principles of the present disclosure. One or more Blocks and/or functions and/or methods performed by the network node 16 may be performed by one or more elements of network node 16 such as by determiner unit 34 in processing circuitry 68, processor 70, radio interface 62, etc. according to the example method. The example method includes receiving (Block S134), such as via determiner unit 34, processing circuitry 68 and/or radio interface 62, information indicating a position for a reference signal within a communication signal slot, the position being indicated relative to a reference point associated with a downlink-to-uplink switch. The method includes at least one of transmitting (Block S136), such as via determiner unit 34, processing circuitry 68 and/or radio interface 62, the reference signal and receiving the reference signal based at least in part on the received information. The method includes determining (Block S138), such as via determiner unit 34, processing circuitry 68 and/or radio interface 62, whether remote interference is present based at least in part on at least one of the received reference signal and the received information indicating the position of the reference signal.

In some embodiments, the method further includes determining, such as via determiner unit 34, processing circuitry 68 and/or radio interface 62, an extent of the remote interference based at least in part on at least one of the received reference signal and the received information indicating the position of the reference signal. In some embodiments, the information indicates the position of the reference signal by mapping the reference signal to physical resources. In some embodiments, the information indicates a time offset for the reference signal. In some embodiments, the information indicating the position of the reference signal is received via Operations, Administration and Maintenance, OAM, signalling. In some embodiments, the reference signal is received from a second network node 16. In some embodiments, the position is a fixed position. In some embodiments, the reference point is a start of a guard period. In some embodiments, the downlink-to-uplink switch corresponds to a time division duplex, TDD, configuration. In some embodiments, the indicated position is in which Orthogonal Frequency Division Multiplexing, OFDM, symbol the reference signal is to be transmitted in.

In some embodiments, the indicated position corresponds to a last downlink, DL, symbol before a start of a smallest guard period. In some embodiments, the method further includes determining, such as via determiner unit 34, processing circuitry 68 and/or radio interface 62, an extent to which the network node is causing interference to a second network node based at least in part on the received reference signal and the received information indicating the position of the reference signal; and increasing, such as via determiner unit 34, processing circuitry 68 and/or radio interface 62, a guard period of the network node 16 based at least in part on the determined extent to which the network node 16 is causing interference to the second network node 16. In some embodiments, the method further includes determining, such as via determiner unit 34, processing circuitry 68 and/or radio interface 62, whether a difference between a symbol on which the reference signal is received and a symbol on which the reference signal was transmitted is greater than a guard period of the network node 16, the indicated position indicating the symbol on which the reference signal was transmitted; and if the difference is greater than the guard period, increasing, such as via determiner unit 34, processing circuitry 68 and/or radio interface 62, the guard period.

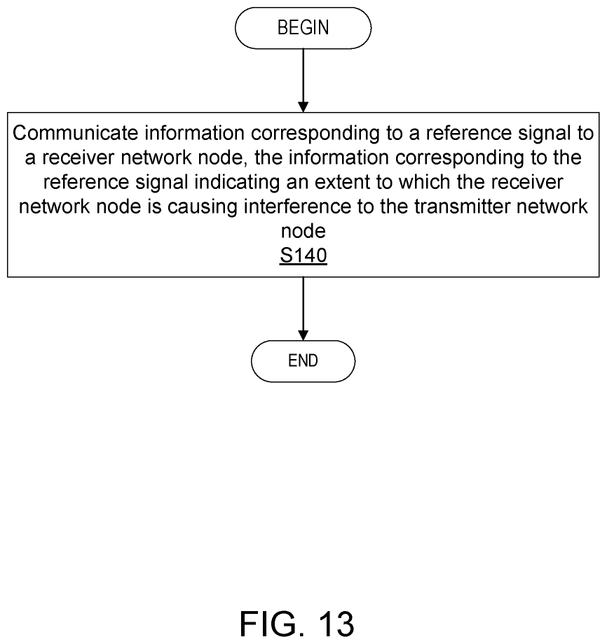

FIG. 13 is a flowchart of an exemplary process in a network node 16 according to at least some of the principles of the present disclosure. In this exemplary process, the network node 16 may be considered a transmitter network node 16c. The transmitter network node 16c communicates information corresponding to a reference signal to a receiver network node 16a, the information corresponding to the reference signal indicating an extent to which the receiver network node 16a is causing interference to the transmitter network node 16c (Block S140).

In some embodiments of this process, the information indicates which Orthogonal Frequency Division Multiplexing (OFDM) symbol the reference signal is transmitted in. In some embodiments, the method further includes communicating the reference signal to the receiver network node. In some embodiments, the communicated reference signal, the communicated information, and a number of symbols in a guard period (GP) of the receiver network node 16a permits the receiver network node 16a to determine the extent to which the receiver network node 16a is causing interference to the transmitter network node 16c. In some embodiments, the information indicates the special subframe configuration of the reference signal. In some embodiments, the information indicates at least one of a length of the guard period, at least one downlink (DL) symbol, and at least one uplink (UL) symbol associated with the reference signal. In some embodiments, the communicating information corresponding to the reference signal to the receiver network node 16a further comprises selecting and communicating a pre-defined sequence, the pre-defined sequence indicating at least one of the special subframe configuration of the reference signal, the guard period length associated with the reference signal, and a number of downlink (DL) symbols within the slot that the reference signal is transmitted in.

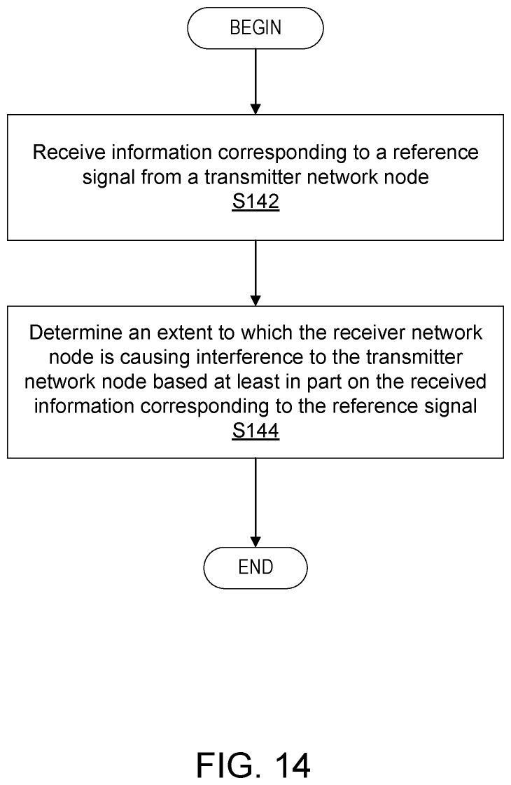

FIG. 14 is a flowchart of an exemplary process in a network node 16 according to some embodiments of the present disclosure. In this exemplary process, the network node 16 may be considered a receiver network node 16a. The receiver network node 16a receives information corresponding to a reference signal from a transmitter network node 16a (Block S142). The receiver network node 16a determines an extent to which the receiver network node 16a is causing interference to the transmitter network node 16c based at least in part on the received information corresponding to the reference signal (Block S144).

In some embodiments, the method further includes increasing a guard period based on the determined extent to which the receiver network node 16a is causing interference to the transmitter network node 16c. In some embodiments, the method further includes receiving the reference signal from the transmitter network node 16c. In some embodiments, the determining the extent to which the receiver network node 16a is causing interface to the transmitter network node 16c further comprises determining whether a difference between an uplink symbol of the received reference signal and a known symbol on which the reference signal was transmitted is greater than a guard period. In some embodiments, the method further includes, if the difference is greater than the guard period, increasing the guard period. In some embodiments, the received information indicates which Orthogonal Frequency Division Multiplexing (OFDM) symbol the reference signal is transmitted in. In some embodiments, the received information indicates the special subframe configuration of the reference signal. In some embodiments, the received information indicates at least one of a length of the guard period, at least one downlink (DL) symbol, and at least one uplink (UL) symbol associated with the reference signal.

Having described some embodiments of the present disclosure relating to determining the extent to which a network node 16 is causing interference with another network node 16, and communicating that extent, a more detailed description of at least some of the embodiments will now be described, and which may be implemented by the network node 16, wireless device 22 and/or host computer 24.

Different Mapping onto the Physical Resources

In one main embodiment, different mappings of the reference signal onto the physical resources is used to convey information. The information may be used by the receiver network node 16 to understand the extent to which interference is caused to the network node 16 that is transmitting the reference signal.

In more detailed embodiments, the information carried can be as follows:

Which OFDM symbol in the subframe the reference signal is transmitted in

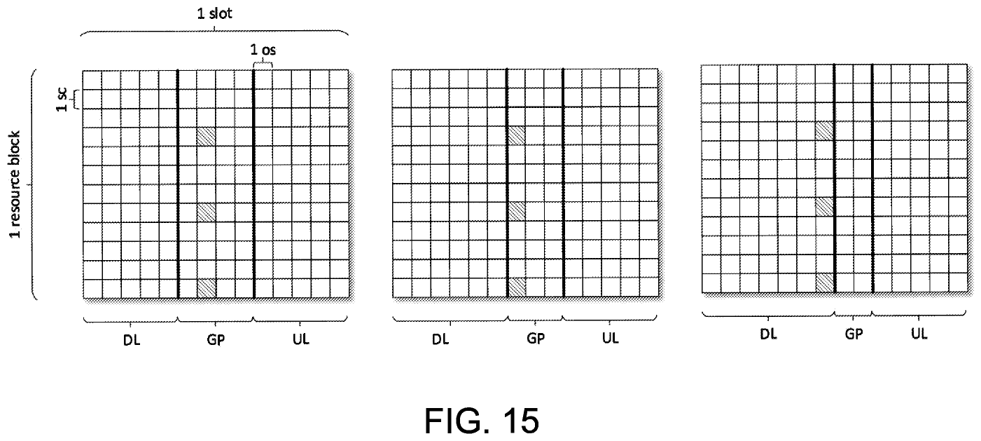

This could for example be in the last symbol given by the smallest guard period configurable in the system, as is illustrated in FIG. 15, as an example.

While using a fixed symbol location results in transmission of the reference signal inside the guard period for some network nodes 16, it may not be a big issue since reference signal transmission is assumed to have a large periodicity and thus only happen occasionally.

Based on in which UL symbol l_{D} the receiving network node 16 detected the transmitted reference signal, the known symbol l_{TX} whereon the reference signal is transmitted and the number of symbols n_{GP} in the GP of the special subframe of the receiving network node 16, the receiving network node 16 would know or determine, such as via processing circuitry 68, that the receiving network node 16 causes interference to the transmitter network node 16 of the reference signal if l_{D}−l_{TX}>n_{GP}.

The receiving network node 16 may then increase, such as via processing circuitry 68 and/or radio interface 62, its GP so that l_{D}−l_{TX}<n_{GP} in order to avoid causing interference to the victim network node 16 which transmitted the detected reference signal.

The Special Subframe/Flexible Slot Configuration Used

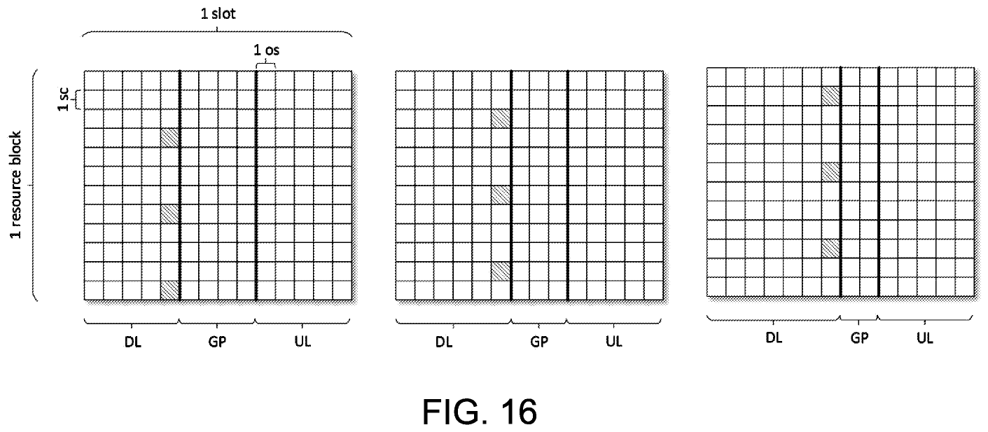

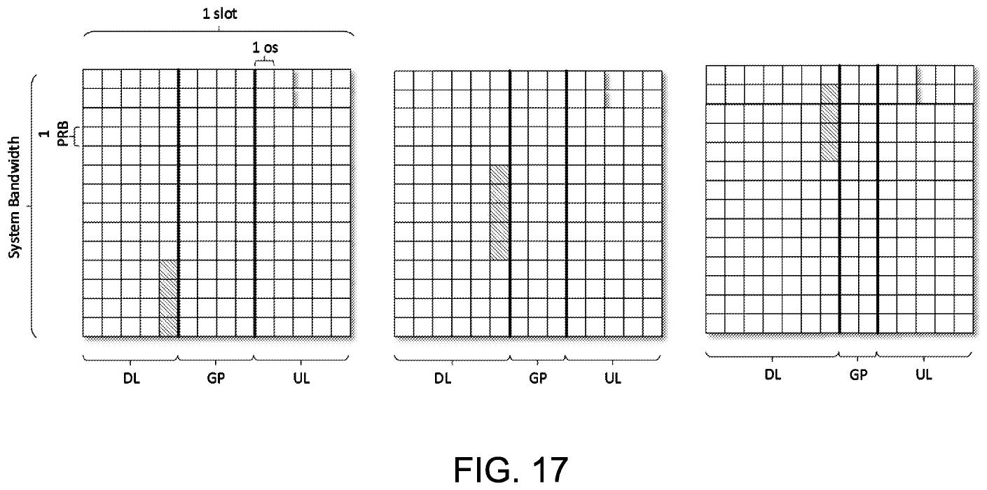

Assume for example that there are three special subframe configurations. Different mapping onto the physical resources may be applied as illustrated in, for example, FIG. 16. That is, depending on which sub-carriers (sc) the reference signal is detected in, the special subframe/flexible slot configuration will be known. By this, it may be known/determined how many OFDM symbols (os) are used for DL transmission. The sub-carrier selection can for example be different combinations in case of IFDMA modulation, or any other mapping in the frequency domain (e.g., equal distant mapping using any given sub-carrier shift between mappings). For instance, difference frequency subbands can be used depending on which OFDM symbol the reference signal is transmitted on, as is illustrated in FIG. 17, as an example.

The length of the guard period and/or DL symbols and/or UL symbols

This may be considered to be similar to the embodiment on special subframe/flexible slot configuration but if for example only DL symbols are of interest, the same reference signal can be used for multiple special subframe configurations, e.g., [DL, GP, UL]: [5,4,5] and [5,3,6].

Restrictions related to in which slots or subframes the sequence is allowed to be transmitted

Assume for example a reference signal can be transmitted every 100 subframes, and that mapping the reference signal is allowed in either OFDM symbol #3 or #4. Indicating OFDM symbol #3 could for example be allowed in subframes {0, 200, 400, . . . } while OFDM symbol #4 in subframes {100, 300, 500, . . . }. This could be applied in any type of mapping restriction in time, not necessarily related to subframes and not necessarily to a fixed spacing in the overall frame structure.

In some embodiments, to maximize detection probability and minimize false detection, different network nodes 16 or groups of network nodes 16 may, in one embodiment, be assigned to transmit in different times. ‘Different times’ here being referred to as a pre-defined time structure for example every Xth subframe with each network node/network node group using a different subframe offset.

As different resource mappings are used to convey information in these sets of embodiments, detection complexity may be increased as the receiver must try to detect a reference signal transmitted by a single victim network node 16 in different locations, each corresponding to different hypotheses of the information conveyed. To mitigate this, in one embodiment, the victim network node 16 transmits the reference signal in two locations. A first location which is fixed and known by the receiving network node 16 and which does not depend on the said information, and a second location which does depend on the said information whereby the selection of the second location conveys the information. This reduces detection complexity at the receiving network node 16 as detection can be split up in at least two steps. In the first step, the receiving network node 16 may try to detect the transmitted reference signal in the first location. If (and only if) a reference signal is detected, the receiving network node 16 in the second step may try to detect a reference signal in each of the possible second locations. Based on which candidate second location the reference signal is detected in, different information is conveyed as discussed in previous embodiments herein. Thus, the receiving network node 16 only needs to search through the candidate second locations when it has detected a reference signal from a certain victim network node 16 transmitted in its corresponding first location.

Adaptive Reference Signal Structure

In another main embodiment, a different structure of the reference signal may be used to convey information. The information may be used by the receiver network node 16 to understand the extent to which interference is caused (by the receiver network node 16) to the network node 16 that is transmitting the reference signal.

In more detailed embodiments, the information carried can be as follows:

By the Sequence Selected

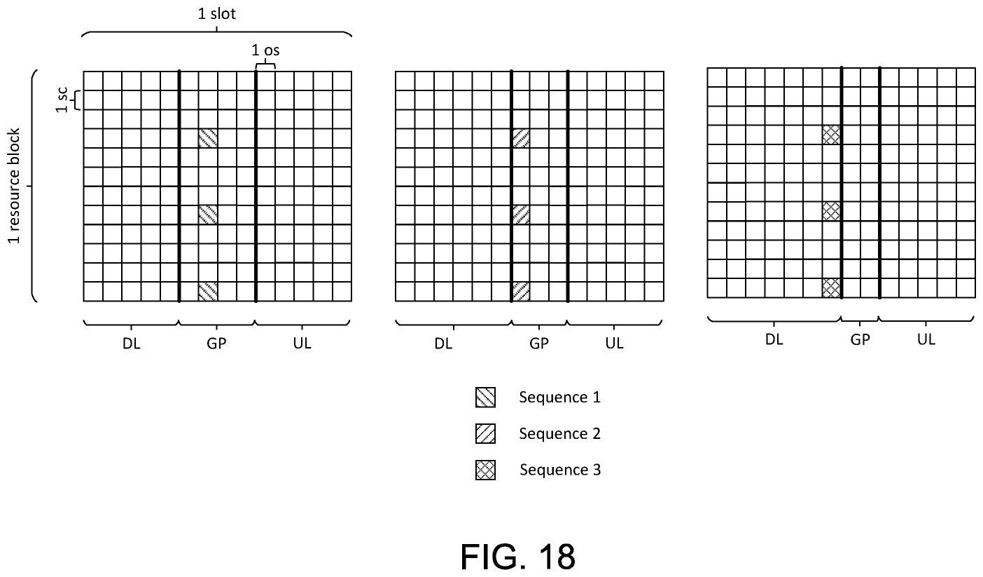

The sequence can be generated by different seed initialization of a pre-defined sequence generator, or for example having pre-defined sequences to select from. The sequence selected can e.g. indicate the special subframe configuration used, the guard period length, or the number of DL symbols or directly the OFDM symbol within the slot the reference signal is transmitted in. See for example FIG. 18. It should be noted that the position of the sequence in the slot need not be fixed (as in this example). Examples of signal sequences generated are Zadoff-Chu sequences, where a different Zadoff-Chu sequence may be selected to convey different information, or PN-sequences such as Gold-sequences or m-sequences where different initialization seeds may be used to convey information.

Mapping and Structure of Reference Signal

It should be noted that, in some embodiments, there may be any combination of the embodiments described above. In other words, any two or more embodiments described in this disclosure may be combined in any way with each other.

As mentioned above, with knowledge of when in time the reference signal is sent, the propagation delay of a detected reference signal can be determined. Since the uplink downlink configurations are assumed to be aligned, in the sense that uplink in all cells is assumed to start simultaneously, the guard period preceding the uplink should be long enough to cover the propagation delay and consequently it is possible to determine how the DL transmission should be shortened (to increase the guard period).

Recall from above, if l_{D} is the received time, then the signaled knowledge about the transmission time l_{TX} makes it possible for the aggressor network node 16 to understand that the guard period should be at least l_{D}−l_{TX}>n_{GP} relative to a nominal uplink starting point.

However, if the transmission time is l_{TX} but l_{TX}−Δ_{GP} is signaled instead of the actual transmission time (where Δ_{GP} is the timing difference between the subframes/slots/subslots of the transmitting and receiving node), then the guard period will be l_{D}−l_{TX}+Δ_{GP}. Consequently, it is possible to signal, such as via radio interface 62, information to mitigate remote interference also for the case with non-aligned uplinks in different cells (if the misalignment is known). This is another embodiment in which the information conveyed is the “extent of the interference.”

In addition, one or more embodiments may include one or more of the following:

Embodiment A1. A transmitter network node configured to communicate with a wireless device (WD), the transmitter network node configured to, and/or comprising a radio interface and/or comprising processing circuitry configured to: communicate information corresponding to a reference signal to a receiver network node, the information corresponding to the reference signal indicating an extent to which the receiver network node is causing interference to the transmitter network node.

Embodiment A2. The transmitter network node of Embodiment A1, wherein the information indicates which Orthogonal Frequency Division Multiplexing (OFDM) symbol the reference signal is transmitted in.

Embodiment A3. The transmitter network node of any one of Embodiments A1 and A2, wherein the processing circuitry is further configured to cause communication of the reference signal to the receiver network node.

Embodiment A4. The transmitter network node of any one of Embodiments A1-A3, wherein the communicated reference signal, the communicated information, and a number of symbols in a guard period (GP) of the receiver network node permits the receiver network node to determine the extent to which the receiver network node is causing interference to the transmitter network node.

Embodiment A5. The transmitter network node of any one of Embodiments A1-A4, wherein the information indicates a special subframe configuration of the reference signal.

Embodiment A6. The transmitter network node of any one of Embodiments A1-A5, wherein the information indicates at least one of a length of a guard period, at least one downlink (DL) symbol, and at least one uplink (UL) symbol associated with the reference signal.

Embodiment A7. The transmitter network node of any one of Embodiments A1-A6, wherein the processing circuitry is further configured to communicate information corresponding to the reference signal to the receiver network node by being further configured to select and communicate a pre-defined sequence, the pre-defined sequence indicating at least one of a special subframe configuration of the reference signal, a guard period length associated with the reference signal, and a number of downlink (DL) symbols within the slot that the reference signal is transmitted in.

Embodiment B1. A method implemented in a network node, the method comprising

communicating information corresponding to a reference signal to a receiver network node, the information corresponding to the reference signal indicating an extent to which the receiver network node is causing interference to the transmitter network node.

Embodiment B2. The method of Embodiment B1, wherein the information indicates which Orthogonal Frequency Division Multiplexing (OFDM) symbol the reference signal is transmitted in.

Embodiment B3. The method of any one of Embodiments B1 and B2, further comprising communicate the reference signal to the receiver network node.

Embodiment B4. The method of any one of Embodiments B1-B3, wherein the communicated reference signal, the communicated information, and a number of symbols in a guard period (GP) of the receiver network node permits the receiver network node to determine the extent to which the receiver network node is causing interference to the transmitter network node.

Embodiment B5. The method of any one of Embodiments B1-B4, wherein the information indicates a special subframe configuration of the reference signal.

Embodiment B6. The method of any one of Embodiments B1-B5, wherein the information indicates at least one of a length of a guard period, at least one downlink (DL) symbol, and at least one uplink (UL) symbol associated with the reference signal.

Embodiment B7. The method of any one of Embodiments B1-B6, wherein the communicating information corresponding to the reference signal to the receiver network node further comprises selecting and communicating a pre-defined sequence, the pre-defined sequence indicating at least one of a special subframe configuration of the reference signal, a guard period length associated with the reference signal, and a number of downlink (DL) symbols within the slot that the reference signal is transmitted in.

Embodiment C1. A receiver network node configured to communicate with a wireless device (WD), the receiver network node configured to, and/or comprising a radio interface and/or comprising processing circuitry configured to: receive information corresponding to a reference signal from a transmitter network node; and

determine an extent to which the receiver network node is causing interference to the transmitter network node based at least in part on the received information corresponding to the reference signal.

Embodiment C2. The receiver network node of Embodiment C1, wherein the processing circuitry is further configured to increase a guard period based on the determined extent to which the receiver network node is causing interference to the transmitter network node.

Embodiment C3. The receiver network node of any one of Embodiments C1-C3, wherein the processing circuitry is further configured to receive the reference signal from the transmitter network node.

Embodiment C4. The receiver network node of Embodiment C3, wherein the processing circuitry is configured to determine the extent to which the receiver network node is causing interface to the transmitter network node by being further configured to determine whether a difference between an uplink symbol of the received reference signal and a known symbol on which the reference signal was transmitted is greater than a guard period.

Embodiment C5. The receiver network node of Embodiment C4, wherein the processing circuitry is further configured to, if the difference is greater than the guard period, increase the guard period.

Embodiment C6. The receiver network node of any one of Embodiments C1-C5, wherein the received information indicates which Orthogonal Frequency Division Multiplexing (OFDM) symbol the reference signal is transmitted in.

Embodiment C7. The receiver network node of any one of Embodiments C1-C6, wherein the received information indicates the special subframe configuration of the reference signal.

Embodiment C8. The receiver network node of any one of Embodiments C1-C7, wherein the received information indicates at least one of a length of a guard period, at least one downlink (DL) symbol, and at least one uplink (UL) symbol associated with the reference signal.

Embodiment D1. A method implemented in a network node, the method comprising:

receiving information corresponding to a reference signal from a transmitter network node; and
determining an extent to which the receiver network node is causing interference to the transmitter network node based at least in part on the received information corresponding to the reference signal.

Embodiment D2. The method of Embodiment D1, further comprising increasing a guard period based on the determined extent to which the receiver network node is causing interference to the transmitter network node.

Embodiment D3. The method of any one of Embodiments D1-D3, further comprising receiving the reference signal from the transmitter network node.

Embodiment D4. The method of Embodiment D3, wherein the determining the extent to which the receiver network node is causing interface to the transmitter network node further comprises determining whether a difference between an uplink symbol of the received reference signal and a known symbol on which the reference signal was transmitted is greater than a guard period.

Embodiment D5. The method of Embodiment D4, further comprising, if the difference is greater than the guard period, increasing the guard period.

Embodiment D6. The method of any one of Embodiments D1-D5, wherein the received information indicates which Orthogonal Frequency Division Multiplexing (OFDM) symbol the reference signal is transmitted in.

Embodiment D7. The method of any one of Embodiments D1-D6, wherein the received information indicates the special subframe configuration of the reference signal.

Embodiment D8. The method of any one of Embodiments D1-D7, wherein the received information indicates at least one of a length of a guard period, at least one downlink (DL) symbol, and at least one uplink (UL) symbol associated with the reference signal.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| BS | Base Station |
| DCI | Downlink Control Information |
| DL | Downlink |
| FDD | Frequency Division Duplex |
| GP | Guard Period |
| LTE | Long Term Evolution |
| NR | New Radio |
| TDD | Time Division Duplex |
| PDCCH | Physical Downlink Control Channel |
| PDSCH | Physical Downlink Shared Channel |
| PUCCH | Physical Uplink Control Channel |
| PUSCH | Physical Uplink Shared Channel |
| RAT | Radio Access Technology |
| RB | Resource Block |
| UE | User Equipment |
| UL | Uplink |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node for remote interference management, the method comprising:
receiving information indicating a position for a reference signal within a communication signal slot, the position being indicated relative to a reference point associated with a downlink-to-uplink switch;
at least one of transmitting the reference signal and receiving the reference signal based at least in part on the received information; and
determining whether remote interference is present based at least in part on at least one of the received reference signal and the received information indicating the position of the reference signal.

2. The method of claim 1, further comprising:
determining an extent of the remote interference based at least in part on at least one of the received reference signal and the received information indicating the position of the reference signal.

3. The method of claim 1, wherein the information indicates the position of the reference signal by mapping the reference signal to physical resources.

4. The method of claim 1, wherein the information indicates a time offset for the reference signal.

5. The method of claim 1, wherein at least one of:
the information indicating the position of the reference signal is received via Operations, Administration and Maintenance, OAM, signalling; and
the reference signal is received from a second network node.

6. The method of claim 1, wherein at least one of:
the position is a fixed position;
the reference point is a start of a guard period; and
the downlink-to-uplink switch corresponds to a time division duplex, TDD, configuration.

7. The method of claim 1, wherein the indicated position is in which Orthogonal Frequency Division Multiplexing, OFDM, symbol the reference signal is to be transmitted in.

8. The method of claim 1, wherein the indicated position corresponds to a last downlink, DL, symbol before a start of a smallest guard period.

9. The method of claim 1, further comprising at least one of:
determining an extent to which the network node is causing interference to a second network node based at least in part on the received reference signal and the received information indicating the position of the reference signal; and
increasing a guard period of the network node based at least in part on the determined extent to which the network node is causing interference to the second network node.

10. The method of claim 1, further comprising to at least one of:
determining whether a difference between a symbol on which the reference signal is received and a symbol on which the reference signal was transmitted is greater than a guard period of the network node, the indicated position indicating the symbol on which the reference signal was transmitted; and
if the difference is greater than the guard period, increasing the guard period.

11. A network node configured to communicate with a wireless device, WD, the network node comprising processing circuitry, the processing circuitry configured to cause the network node to:
receive information indicating a position for a reference signal within a communication signal slot, the position being indicated relative to a reference point associated with a downlink-to-uplink switch;
at least one of transmit the reference signal and receive the reference signal based at least in part on the received information; and
determine whether remote interference is present based at least in part on at least one of the received reference signal and the received information indicating the position of the reference signal.

12. The network node of claim 11, wherein the processing circuitry is further configured to cause the network node to:
determine an extent of the remote interference based at least in part on at least one of the received reference signal and the received information indicating the position of the reference signal.

13. The network node of claim 11, wherein the information indicates the position of the reference signal by mapping the reference signal to physical resources.

14.-18. (canceled)

19. The network node of claim 11, wherein the processing circuitry is further configured to cause the network node to at least one of:
determine an extent to which the network node is causing interference to a second network node based at least in part on the received reference signal and the received information indicating the position of the reference signal; and
increase a guard period of the network node based at least in part on the determined extent to which the network node is causing interference to the second network node.

20. The network node of claim 11, wherein the processing circuitry is further configured to cause the network node to at least one of:
determine whether a difference between a symbol on which the reference signal is received and a symbol on which the reference signal was transmitted is greater than a guard period of the network node, the indicated position indicating the symbol on which the reference signal was transmitted; and
if the difference is greater than the guard period, increase the guard period.

21. The method of claim 2, wherein the information indicates the position of the reference signal by mapping the reference signal to physical resources.

22. The method claim 21, wherein the information indicates a time offset for the reference signal.

23. The method of claim 22, wherein at least one of:
the information indicating the position of the reference signal is received via Operations, Administration and Maintenance, OAM, signalling; and
the reference signal is received from a second network node.

24. The method claim 2, wherein the information indicates a time offset for the reference signal.

25. The method of claim 2, wherein at least one of:
the information indicating the position of the reference signal is received via Operations, Administration and Maintenance, OAM, signalling; and
the reference signal is received from a second network node.
